(19) United States
(12) Patent Application Publication
(10) Pub. No.: US 2005/0078228 A1
(43) Pub. Date: Apr. 14, 2005

(54) Arrangement for generating images

(76) Inventors: Ingo Klemm, Jena (DE); Joachim Rulf, Jena (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/949,771

(22) Filed: Sep. 24, 2004

(30) Foreign Application Priority Data
Sep. 26, 2003 (DE) 103 45 371.7

(51) Int. Cl. G02B 26/00

(52) U.S. Cl. 348/771; 353/30

(57) ABSTRACT

The invention relates to an arrangement for generating images, preferably for use in televisions or projectors that operate in accordance with the principles of rear and front projection, including an illumination device, a color modulator, an image-generating element with tilt-mirror elements (DMD or digital micromirror device), as well as a projection lens, wherein the light component emitted by the illumination unit is reflected by the DMD and the light component contributing to the image structure reaches the image plane via the project lens. According to the invention, a tilting mirror that can be pivoted about a tilting axis is provided in the projection beam path and is connected to drive elements that supply the pivoting movements.

### FIELD OF THE INVENTION

The invention relates to an arrangement for generating images, preferably for use in televisions or projectors that operate in accordance with the principles of rear or front projection, including an illumination device, a color modulator, an image-generating element with tilt-mirror elements (DMD or digital micromirror device), as well as a projection lens, wherein the light component emitted by the illumination unit is reflected by the DMD and the light component contributing to the image structure reaches the image plane via the projection lens.

### BACKGROUND OF THE INVENTION

In projector and television engineering, it is known that the light of a projection lamp is projected through a color wheel onto a DMD chip that is from Texas Instruments and that is provided with a plurality of mirrors. Thousands of tiny mirrors, each of which corresponds to one Pixel and reflects the light with only minimal loss, are disposed on a DMD chip. The mirrors are moveably mounted in the number of the multiplied resolution. Depending on the position of the mirrors, more or less light reaches a projection screen. As is known in the art, the mirrors are arranged such that the edges lie in a vertical and horizontal direction (HD 2 chip from Texas Instruments).

Chips of this nature have a large number of mirror elements and can only be produced at a high cost. To reduce the production cost (fewer mirrors) with virtually unchanging quality in optical perception of the viewer, a variant was proposed in which the mirrors are arranged on the chip such that the diagonals are disposed in a horizontal and vertical position.

A significant disadvantage of this solution is that horizontal and vertical lines have visible edge structures, which significantly diverges from the images to which the customer was previously accustomed.

For this reason, the object of the invention is to create an arrangement for generating images, using DMD chips as image-generating elements, that eliminates pixel errors with regard to resolution and distortion, even in the case of mirror arrangements with horizontally and vertically disposed diagonals.

According to the invention, this object is achieved by an arrangement of the type described initially in that a tilting mirror that can be pivoted about a tilting axis is provided that is connected to drive elements that supply the pivoting movements.

Advantageously, pivoting of the tilting mirrors about the tilting axis should fall within a range of a few μm.

As a result of the arrangement of the tilting mirror and the supply of pivoting, defined image distortion or image blurring occurs, so that, for example, the contours of the pixels visible to the viewer are blurred and thus no longer visible when the tilting mirrors are arranged with the mirror diagonals in horizontal and vertical positions. This means that the resolution of the image is improved.

In one advantageous embodiment, the drive elements comprise a ferromagnetic tilting mirror receptacle that is coupled to a magnetic reversal unit that generates magnetic fields, wherein the tilting mirror is mounted on the receptacle such that the change in length of the receptacle caused by the magnetic reversal (magnetostriction) results in a pivoting movement of the tilting mirror about the tilting axis.

In this connection, the angle velocity of the tilting mirror is, for the most part, proportional to the velocity of the magnetic field change. Driving the field coil with defined frequencies in the low-frequency range results in analogous geometry changes in the field coil core, which are transmitted to the tilting mirror. The necessary pivoting movement of the tilting mirror is adjusted by changing the voltage and the frequency of the coil drive.

In another advantageous embodiment of the drive elements, the tilting mirror receptacle is connected to an anchor pivotably arranged between two coils that are wrapped in opposing directions such that the pivoting of the anchor can be transmitted to the tilting mirror (differential transformer). In this connection, the coils are connected in series and a direct current flows through them; it is driven by a +/−voltage source that is symmetrical in relation to ground.

Again relative to ground, an approx. 0V difference arises at the point of connection of the coils. The anchor is fixed in the middle position by the two magnetic fields.

If, for example, the output of one operation amplifier that is supplied with a +/−voltage analogous to the coil supply is connected to the coil connection, the zero position of the anchor can be statically set via the operation amplifier. This can also be used to cause the anchor to pivot in the alternating field. Thus, the voltage and frequency at the input of the operation amplifier determine the movement of the anchor, which is transmitted to the tilting mirror receptacle in the form of pivoting movements.

One relatively simple solution for supplying the pivoting movements to the tilting mirror is to couple the tilting mirror to an oscillating capacitor. The principle is based on plates with opposite charges attracting one another and repelling one another when their charges are identical. In this connection, the tilting mirror receptacle can be provided, for example, with an electrically conductive coating made of chrome, silver, gold, or copper that operates against a fixed, electrically conductive plate. Depending on its mounting, the tilting mirror receptacle is caused to pivot by an alternating field between the tilting mirror receptacle and the fixed, electrically conductive plate. In this variant, as well, the voltage and frequency of the capacitor voltage determine the movement of the mirror.

Another option for driving the tilting mirror is embodying the tilting mirror receptacle on a pressure sensor unit embodied as a curved plate that can be caused to pivot by means of electrical impulses in accordance with the principles of piezo technology.

While the bending effect of a plate is used in this case to generate the pivoting of the tilting mirror, another advantageous embodiment comprises coupling the tilting mirror receptacle to a piezoactor that generates one or more pivots. In this connection, the tilting mirror receptacle is disposed on a piezoceramic that is constructed of a plurality of alternating thin ceramic layers and electrodes, the characteristic of which is that it expands or contracts up to 100,000 times per second, depending on the power supply (on/off), thereby transmitting pivots to the tilting mirror receptacle.

### BRIEF DESCRIPTION OF THE DRAWINGS

The arrangement according to the invention is described in greater detail in a following exemplary embodiment. The corresponding figures show:

FIG. 1: the depiction of the illuminating arrangement with tilting mirror,

FIG. 2: an exploded view of the tilting mirror in the tilting mirror receptacle,

FIG. 3: a depiction of the mounted tilting mirror in the tilting mirror receptacle,

FIG. 4: a sectional view B-B from FIG. 3 and

FIG. 5: a sectional view A-A from FIG. 4.

### DETAILED DESCRIPTION OF THE INVENTION

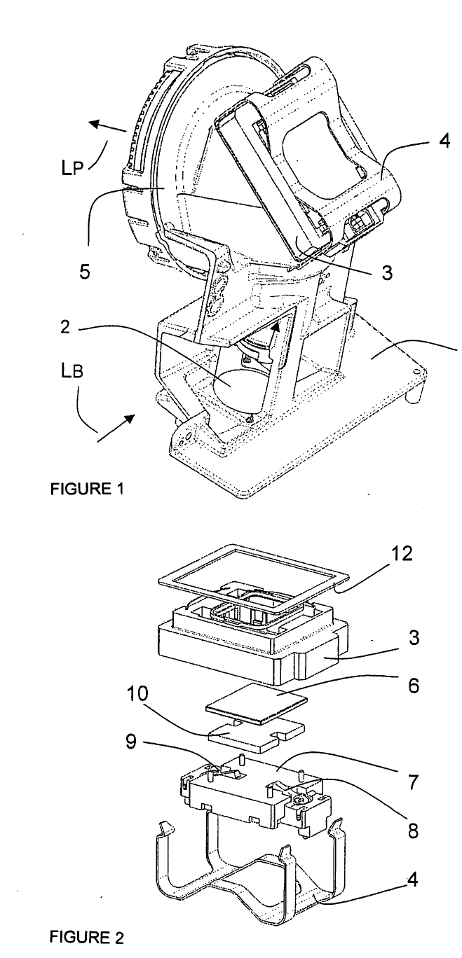

FIG. 1 shows the housing 1 of the inventive illumination arrangement for the component of the projection beam path LP, wherein the light LB emitted by an illumination device, which is not shown, enters the housing 1 laterally and strikes a tilting mirror arrangement (DMD) 2.

The light component LP needed for image projection reaches the image plane via the inventively arranged pivotable tilting mirror, of which only the frame of the tilting mirror receptacle 3 and the fastening clip 4, which comprises spring steel and secures the tilting mirror receptacle 3 to the housing 1, are visible in FIG. 1, and the projection lens 5.

An exploded view of the entire mounting and movement system of the tilting mirror 6 is visible in FIG. 2, wherein the piezo housing 7 is shown beginning at the fastening clip 4. The piezo housing 7 receives two oppositely arranged piezo motors 8 and 9, and also supports the tilting mirror 6. In addition, a cushion pad 10 comprising sponge rubber is disposed between the tilting mirror 6 and the piezo housing 7. The piezo housing 7 is integrated into the frame 3 of the tilting mirror receptacle together with the tilting mirror 6 and the cushion pad 10. For the purpose of fixing the position of the tilting mirror 6 on the piezo housing 7, four buffer cylinders 11 are provided in the direction of the piezo motors 8 and 9. The entire tilting mirror receptacle is secured to the housing 1 via the fastening clip 4 and a foam rubber ring 12.

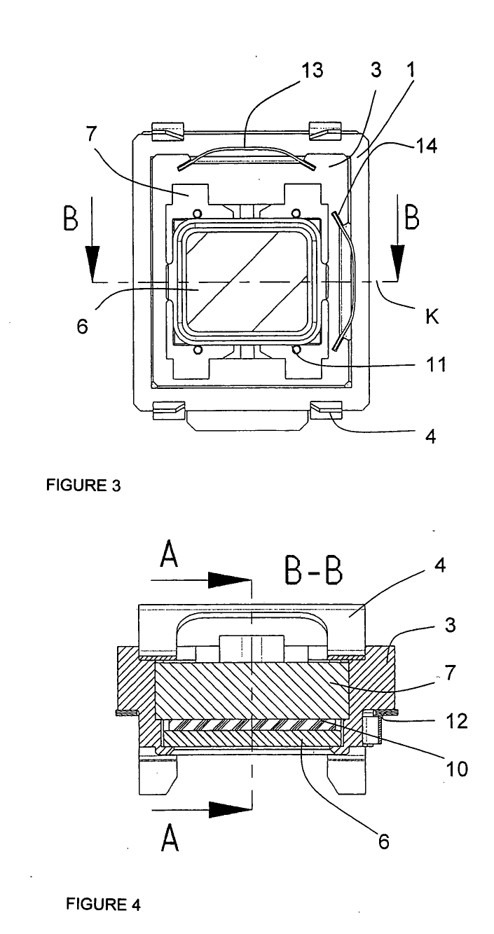

FIG. 3 shows the tilting mirror receptacle from the perspective of the tilting mirror 6 that transmits the projection beam path LP into the image plane. The spring tension clamps 13 and 14 fix the position of the frame 3 of the tilting mirror receptacle in the housing 1.

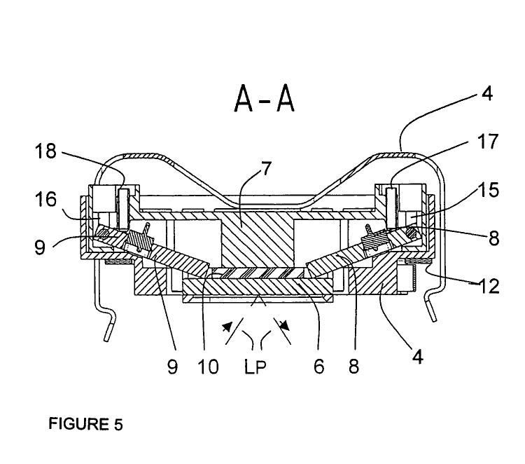

To further illustrate the structure of the mounting and the mode of operation of the pivotable tilting mirror 6, sectional views of the tilting mirror receptacle are shown in FIGS. 4 and 5.

The section B-B shown in FIG. 4, from the perspective of FIG. 3, shows in detail the positioning of the tilting mirror 6 and the cushion pad 10, and the arrangement of the piezo housing 7 in the frame 3.

In FIG. 5, the sectional view A-A from the perspective of FIG. 4 shows the positions of the piezoactors 8 and 9. For the purpose of the defined supply of pivoting movements on the tilting mirror 6, the piezoactors 8 and 9 are received in sealing ports 15 and 16 and then oriented and fixed in their position relative to the tilting mirror 6 via adjusting elements 17 and 18. After the piezoactors 8 and 9 are received, the sealing ports 15 and 16 are filled with a two-component adhesive. By activating the piezo motors 8 and 9, defined pivoting movements with a stroke of a few μm are supplied to the tilting mirror 6, so that said tilting mirror performs movements about an axis that, in the present exemplary embodiment, corresponds to the sectional axis B-B (tilt axis K) shown in FIG. 3, said movements resulting in image blurring, so that diagonal contours of the pixels are no longer visible to the observer when the tilting mirrors are arranged with the mirror diagonals in a horizontal and vertical position.

List of Reference Symbols
1 Housing
2 Tilting mirror array (DMD)
3 Frame
4 Fastening clamp
5 Projection lens
6 Tilting mirror
7 Piezo housing
8,9 Piezoactor
10 Cushion pad
11 Buffer cylinder
12 Foam rubber ring
13,14 Spring tension clamp
15,16 Sealing ports
17,18 Adjusting element
LB Illumination beam path
LP Projection beam path
K Tilt axis

1. An arrangement for generating images, for use in rear and front projection systems, the projection system comprising an illumination device, a color modulator, an image-generating element with a tilting-mirror matrix, a projection lens, wherein a light beam emitted by the illumination device is reflected by the tilting-mirror matrix and then passes to an image plane via the projection lens, the arrangement comprising a tilting mirror tiltable about a tilting axis and located in a beam path, the tilting mirror being operably connected to drive elements that actuate tilting movements.

2. The arrangement for generating images according to claim 1, wherein movement of the tilting mirror about the tilting axis falls within a range of two to ten micrometers.

3. The arrangement for generating images according to claim 1, wherein the tilting mirror is operably coupled to at least one piezo-actuator that actuates tilting.

4. The arrangement for generating images according to claim 1, wherein the drive elements comprise a ferromagnetic tilting mirror receptacle that is coupled to a magnetic reversal unit that generates magnetic fields, wherein the tilting mirror is mounted on the receptacle such that the change in length of the receptacle caused by the magnetic reversal results in a pivoting movement of the tilting mirror about the tilting axis.

5. The arrangement for generating images according to claim 1, further comprising a tilting mirror receptacle connected to an anchor pivotably arranged between two coils wrapped in opposing directions such that the pivoting of the anchor is transmitted to the tilting mirror.

6. The arrangement for generating images according to claim 1, comprising an oscillating capacitor coupled to the tilting mirror to tilt the tilting mirror.

7. The arrangement for generating images according to claim 1, wherein the tilting mirror is held in a receptacle disposed on a pressure transducer unit tiltable by electrical impulses in accordance with the principles of piezo technology.

8. An image generating assembly for use with a projector comprising:
a tilting mirror tiltable about a tilting axis and located in a beam path, and
drive elements operably connected to the tilting mirror that actuate tilting movements.

9. The image generating assembly as claimed in claim 8, in which the drive elements comprise piezo-actuators.

10. The image generating assembly as claimed in claim 8, in which the drive elements comprise wherein the drive elements comprise a ferromagnetic tilting mirror receptacle that is coupled to a magnetic reversal unit that generates magnetic fields, wherein the tilting mirror is mounted on the receptacle such that the change in length of the receptacle caused by the magnetic reversal results in a pivoting movement of the tilting mirror about the tilting axis.

11. The image generating assembly as claimed in claim 8, further comprising a tilting mirror receptacle connected to an anchor pivotably arranged between two coils wrapped in opposing directions such that the pivoting of the anchor is transmitted to the tilting mirror.

12. The arrangement for generating images according to claim 8, comprising an oscillating capacitor coupled to the tilting mirror, to tilt the tilting mirror.

13. The arrangement for generating images according to claim 8, wherein the tilting mirror is held in a receptacle disposed on a pressure transducer unit tiltable by electrical impulses in accordance with the principles of piezo technology.

14. A method of altering image quality in a projected image, the method comprising the steps of:
generating an image at a tilting mirror matrix;
directing a light beam at the tilting mirror matrix to be reflected;
receiving the reflected light beam on a tilting mirror tiltable about a tilting axis the tilting mirror being operably connected to drive elements that actuate tilting movements;
tilting the tilting mirror to blur the image thereby making the projected image more acceptable to an observer.

15. The method as claimed in claim 14, further comprising the step of utilizing a piezo-actuator to actuate the tilting.

16. The method as claimed in claim 14, further comprising the steps of mounting the mirror on ferro-magnetic receptacle coupled to a magnetic reversal unit that generates magnetic fields; and
generating a magnetic field such that the receptacle changes in length thus tilting the mirror about the tilting axis.

17. The method as claimed in claim 14, further comprising the steps of coupling the mirror to an anchor;
locating the anchor between two anchors; and
utilizing two coils to pivot the anchor in opposite directions thus tilting the mirror.

18. The method as claimed in claim 14, further comprising the steps of coupling and oscillating capacitor to the mirror; and
actuating the oscillating capacitor to tilt the mirror.

19. The method as claimed in claim 14, further comprising the steps of mounting the mirror in a receptacle disposed on a piezoelectric pressure transducer; and
applying electrical impulses the pressure transducer to actuate tilting of the mirror.

20. A projector comprising:
a source of illumination;
a color modulator following the illumination device;
a tilting mirror matrix to generate images following the color modulator;
a tilting mirror following the tilting mirror matrix, the tilting mirror being tiltable about a tilting axis and being operably coupled to a drive element to actuate tilting movement of the tilting mirror; and
a projection lens following the tilting mirror.

21. The projector as claimed in claim 20, wherein the drive element comprises at least one piezo-actuator operably coupled to the tilting mirror.

22. The projector as claimed in claim 20, wherein the drive element comprises a ferromagnetic mirror receptacle, to support the tilting mirror, coupled to a magnetic reversal unit that generates magnetic fields such that change in shape of the ferromagnetic mirror receptacle caused by the magnetic reversal unit creates a pivoting movement of the tilting mirror about the tilting axis.

23. The projector as claimed in claim 20, wherein the drive element comprises at least one oscillating capacitor coupled to the tilting mirror.

24. The projector as claimed in claim 20, wherein the drive element comprises at least one piezoelectric pressure transducer tiltable by the application of electrical impulses.
